(19) United States
(12) Patent Application Publication
(10) Pub. No.: US 2013/0080679 A1
(43) Pub. Date: Mar. 28, 2013

(54) SYSTEM AND METHOD FOR OPTIMIZING THERMAL MANAGEMENT FOR A STORAGE CONTROLLER CACHE

(71) Applicant: Luca Bert, Cumming, GA (US)

(72) Inventor: Luca Bert, Cumming, GA (US)

(73) Assignee: LSI CORPORATION, Milpitas, CA (US)

(21) Appl. No.: 13/245,302

(22) Filed: Sep. 26, 2011

(51) Int. Cl. G06F 12/02

(52) U.S. Cl. 711/102; 711/E12.008

(57) ABSTRACT

The present invention is directed to a method for optimizing thermal management for a storage controller cache of a data storage system. The method allows for pending writes of a storage controller to be selectively provided to solid-state device (SSD) module(s) of the controller in a manner which allows operating temperatures of the SSD module(s) to be maintained within a thermal envelope.

### FIELD OF THE INVENTION

The present invention relates to the field of data management via data storage systems (ex.—external, internal/Direct-Attached Storage (DAS), Redundant Array of Inexpensive Disks (RAID), software, enclosures, Network-Attached Storage (NAS) and Storage Area Network (SAN) systems and networks) and particularly to a system and method for optimizing thermal management for a storage controller cache.

### BACKGROUND OF THE INVENTION

Currently available data storage systems may not provide a desirable level of performance.

Therefore, it may be desirable to provide a data storage solution which addresses the shortcomings of currently available solutions.

### SUMMARY OF THE INVENTION

Accordingly, an embodiment of the present disclosure is directed to a method for optimizing thermal management for a storage controller cache of a data storage system, the method including: establishing a write credit threshold for a solid-state drive (SSD) module of the controller at a first value, the first value being greater than zero; detecting an operating temperature of the SSD module; comparing the detected operating temperature of the SSD module with at least one of: a first temperature parameter value of the SSD module and a second temperature parameter value of the SSD module; when comparing indicates that the detected operating temperature of the SSD module is less than the first temperature parameter value, and when the write credit threshold of the SSD module is established at the first write credit threshold value, causing the controller to issue a first percentage of the controller's pending writes to the SSD module, the first percentage corresponding to the first value of the write credit threshold; when comparing indicates that the detected operating temperature of the SSD module is greater than the first temperature parameter value, but less than the second temperature parameter value, and when the write credit threshold of the SSD module is established at the first write credit threshold value, adjusting the write credit threshold to a second value, the second write credit threshold value being a lesser value than the first write credit threshold value, and causing the controller to issue a second percentage of its pending writes to the SSD module, the second percentage being less than the first percentage and corresponding to the second value of the write credit threshold; and when comparing indicates that the detected operating temperature of the SSD module is equal to or greater than the second temperature parameter value and when the write credit threshold is at a value greater than zero, reducing the write credit threshold to a value equal to zero and causing the controller to stop issuing pending writes to the SSD module.

A further embodiment of the present disclosure is directed to a non-transitory, computer-readable medium having computer-executable instructions for performing a method for optimizing thermal management for a storage controller cache of a data storage system, the method including: establishing a write credit threshold for a solid-state drive (SSD) module of the controller at a first value, the first value being greater than zero; detecting an operating temperature of the SSD module; comparing the detected operating temperature of the SSD module with at least one of: a first temperature parameter value of the SSD module and a second temperature parameter value of the SSD module; when comparing indicates that the detected operating temperature of the SSD module is less than the first temperature parameter value, and when the write credit threshold of the SSD module is established at the first write credit threshold value, causing the controller to issue a first percentage of the controller's pending writes to the SSD module, the first percentage corresponding to the first value of the write credit threshold; when comparing indicates that the detected operating temperature of the SSD module is greater than the first temperature parameter value, but less than the second temperature parameter value, and when the write credit threshold of the SSD module is established at the first write credit threshold value, adjusting the write credit threshold to a second value, the second write credit threshold value being a lesser value than the first write credit threshold value, and causing the controller to issue a second percentage of its pending writes to the SSD module, the second percentage being less than the first percentage and corresponding to the second value of the write credit threshold; and when comparing indicates that the detected operating temperature of the SSD module is equal to or greater than the second temperature parameter value and when the write credit threshold is at a value greater than zero, reducing the write credit threshold to a value equal to zero and causing the controller to stop issuing pending writes to the SSD module.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the present invention may be better understood by those skilled in the art by reference to the accompanying figure(s) in which:

FIG. 1 is a block diagram illustration of a data storage system in accordance with an exemplary embodiment of the present disclosure; and

FIG. 2 is a flowchart which illustrates a method for optimizing thermal management for a storage controller cache in a data storage system (such as the data storage system shown in FIG. 1), in accordance with exemplary embodiments of the present disclosure.

### DETAILED DESCRIPTION OF THE INVENTION

Reference will now be made in detail to the presently preferred embodiments of the invention, examples of which are illustrated in the accompanying drawings.

The introduction of flash devices and solid-state devices has created a new era of storage management based upon storage tiers, each storage tier being characterized mainly by its access time. For example, the flash devices and solid-state devices may be used as local storage, caches and/or tiers, and may be integrated inside a data storage system. Most common tiers are solid-state drive (SSD)-based tiers or hard disk drive (HDD)-based tiers, where access time difference may on the order of one hundred times (100×). Some issues that arise from implementing these flash devices and solid-state devices in the above-described manner involve the introduction of high power concentration and the related thermal issues that accompany high power concentration. Therefore, it may be desirable to provide a storage acceleration solution which addresses the above-referenced shortcomings of currently available solutions.

In the present disclosure, method(s) are introduced for promoting improved thermal management in systems which implement flash devices or solid-state devices for providing caching and tiering. Further, in the present disclosure, method(s) are introduced for promoting improved data mapping in systems, such that thermal profiles are used as a parameter for data mapping. Still further, in the present disclosure, method(s) are introduced for providing data mapping (ex.—data placement) which is optimized for thermal impact.

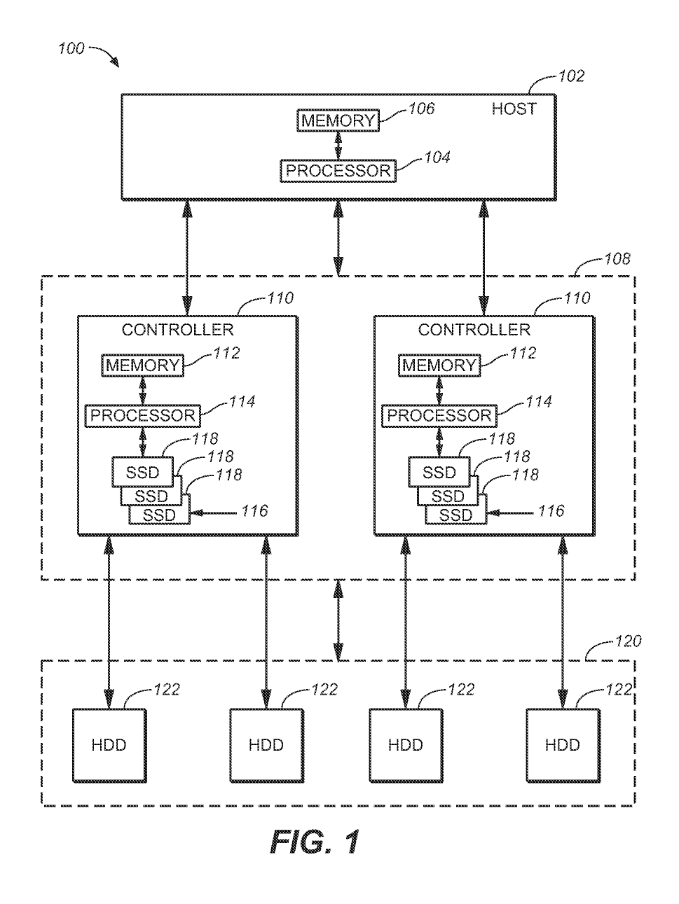

Referring to FIG. 1, a data storage system in accordance with an exemplary embodiment of the present disclosure is shown. In exemplary embodiments, the data storage system 100 may include a host computer system (ex.—a host system; a host; a network host) 102. The host computer system 102 may include a processing unit 104 and a memory 106, the memory 106 being connected to the processing unit 104. The host 102 may be configured for generating and transmitting I/O commands, and may further be configured for receiving data responsive to the I/O commands.

In further embodiments, the system 100 may include a controller layer 108. The controller layer 108 may be connected to the host system 102 and may include one or more controllers (ex.—storage controller(s); disk array controller(s); Redundant Array of Independent Disks (RAID) controller(s); Communication Streaming Architecture (CSA) controller(s); adapter(s)) 110. For instance, the controller(s) 110 may be communicatively coupled with the host 102. The controller(s) 110 may be configured for receiving the I/O commands from the host 102 and for generating and transmitting controller outputs (ex.—read commands (reads), write commands (writes)) based on the I/O commands received from the host 102. The controller(s) 110 may further be configured for obtaining data responsive to the host I/O commands and providing the data to the host 102.

In exemplary embodiments of the present disclosure, each of the controllers 110 of the controller layer 108 may include a memory (ex.—controller cache; cache memory; a random-access memory (RAM); a dynamic random-access memory (DRAM)) 112. Each of the controllers 110 may further include a processing unit 114, the processing unit 114 being connected to the cache memory 112.

In further embodiments, the controller layer 108 (ex.—controller(s) 110 of the controller layer 108) may be connected to (ex.—communicatively coupled with) a first storage subsystem (ex.—a first storage tier; a fast tier) 116. In exemplary embodiments, the first storage tier 116 may be a solid-state drive-based storage tier which may include one or more solid-state disk drives (ex.—solid-state drives (SSDs); SSD modules; SSD devices) 118. For instance, each controller 110 may be storage controller card 110 and may have one or more of the SSD(s) 118, embedded in, mounted on, hosted by and/or stacked upon it.

In further embodiments, the controller layer 108 (ex.—controller(s) 110 of the controller layer 108) may be connected to (ex.—communicatively coupled with) a second storage subsystem (ex.—a second storage tier; a slow tier) 120. In an embodiment of the present disclosure, the second storage tier 120 may be a hard disk drive-based storage tier which includes one or more hard disk drives (HDDs) 122.

In exemplary embodiments, the system 100 may further include one or more temperature sensors (not shown) which are connected to the SSD(s) 118 (and also connected to the controller 110) for sensing temperature(s) (ex.—a current operating temperature(s)) of the SSD(s) 118.

As mentioned above, the SSDs 118 may be implemented to form a fast storage tier (ex.—a fast local storage tier; a fast local cache) 116 for the system 100. For example, in the data storage system 100 disclosed herein, a software algorithm of a program running on a processor of the storage system 100 may be implemented for determining which data is most frequently accessed (ex.—hot spot data) and for storing (ex.—caching) that data in the SSDs 118. For instance, the hot spot data may be copied from the HDDs 122 (ex.—slower tier) to the SSDs 118 (ex.—faster tier). Further, the controller 110 may then make subsequent reads of the hot spot data from the SSDs 118 for promoting improved (ex.—accelerated) performance of the system 100. Still further, the controller 110 may cache some writes on the SSDs 118 until such time that the writes may be passed along to the HDDs 122 in an unobtrusive manner (ex.—at a time when the system 100 is not performing a large read from the HDDs 122), thereby promoting improved performance of the system 100. Further, as mentioned above, multiple SSDs 118 may be embedded in, mounted on, hosted by and/or stacked upon a same controller (ex.—a same storage controller; a same storage controller card) 110. By implementing multiple SSDs 118 on a same storage controller card 110 (as in the system 100 of the present disclosure), a very large amount of storage may be provided on the storage controller (ex.—storage controller card) 110 itself which may be accessed at high speed. However, each SSD 118 may have a thermal behavior that exceeds the capability of the controller 110 upon which it is mounted and/or exceeds the capability of the system 100 within which it is hosted. The present disclosure addresses this by providing a method which promotes maximized performance of the data storage system 100, while also promoting the ability of the system 100 to stay within a pre-determined (and if necessary, a programmable) thermal envelope. The method is described below.

In implementing the system(s) and method(s) disclosed herein, a few elements may apply and/or may be considered. For instance, input/output (I/O) operations such as read operations (ex—reads) may be deemed as being more important than other I/O operations, such as write operations (ex.—writes), since writes may be buffered on other devices (ex.—controller RAM). Further, writes may have a much higher impact on thermal dissipation, since the process of erasing and then writing flash blocks may require much more energy than reads. Still further, the ability to coalesce I/O operations (I/Os) into larger chunks (ex.—one 64K write rather than sixteen 4K writes may further diminish the power footprint of the system. Further, I/O throttling may not be desirable unless it is the last resort to manage thermal envelopes.

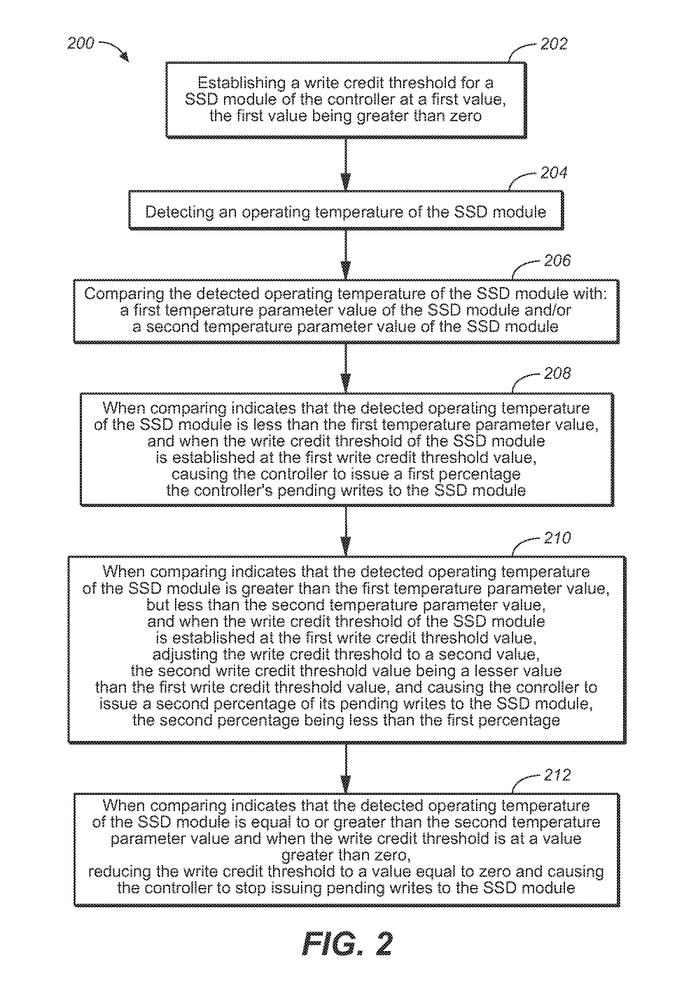

FIG. 2 is a flowchart which illustrates a method for optimizing thermal management for a storage controller cache of a data storage system, in accordance with an embodiment of the present disclosure. In an exemplary embodiment of the present disclosure, the method 200 may include the step of establishing a write credit threshold for a SSD module of the controller at a first value, the first value being greater than zero 202. For example, the first value may be equal to a maximum number of outstanding writes the SSD module 118 of the controller 110 may be able to support concurrently (ex.—at one time). Further, this write credit threshold may be established at boot time of the system 100 and may be throttled at runtime of the system 100. Still further, write credit threshold(s) may be established (ex.—set) for each SSD module 118 of the controller 110. In an embodiment of the present disclosure, the write credit threshold may be set to a same value for each SSD module 118 of the controller 110. In alternative embodiments, the SSD modules 118 of the controller 110 may have different write threshold values relative to each other based upon differing I/O and/or thermal characteristics of the SSD modules 118. For instance, if the SSD modules 118 of the controller 110 are in a stacked configuration, SSD modules located in the middle of the stack may have more thermal limitations than SSD modules located at the ends of the stack. Thus, one may wish to limit thermal impact differently for the SSD modules in the middle of the stack compared to SSD modules at the ends of the stack by establishing the write credit thresholds for the SSD modules in the middle of the stack at a lower value compared to the write credit thresholds for the SSD modules at the ends of the stack.

In further embodiments of the present disclosure, the method 200 may further include the step of detecting an operating temperature (ex.—a current operating temperature) of the SSD module 204. In still further embodiments, the method 200 may further include the step of comparing the detected operating temperature of the SSD module with at least one of: a first temperature parameter value of the SSD module and a second temperature parameter value of the SSD module 206. In exemplary embodiments, the first and second temperature parameters are established (ex.—set) at pre-determined values. For example, the first temperature parameter (ex.—a throttle temperature) may be established at a first temperature value, while the second temperature parameter (ex.—a runoff temperature) may be established at a second temperature value, the second temperature value being larger than (ex.—greater than; higher than) the first temperature value. In further embodiments, the second temperature parameter (ex.—runoff temperature) may be equivalent to a maximum operating temperature the SSD module can reach which cannot be exceeded without compromising reliability of the SSD module. Still further, the first and second temperature parameters may be established for each SSD module 118 of the controller 110. In an embodiment of the present disclosure, the first temperature parameter may be established at a same temperature value for each SSD module 118 of the controller 110. Further, the second temperature parameter may be established at a same temperature value for each SSD module 118 of the controller 110. In alternative embodiments, the SSD modules 118 of the controller 110 may have different first temperature parameter temperature values relative to each other and/or different second temperature parameter temperature values relative to each other based upon differing I/O and/or thermal characteristics of the SSD modules 118.

In exemplary embodiments of the present disclosure, the method 200 may further include the step of, when comparing indicates that the detected operating temperature of the SSD module is less than the first temperature parameter value, and when the write credit threshold of the SSD module is established at the first write credit threshold value, causing the controller to issue a first percentage (ex.—all; 100%) of its (the controller's) pending writes to the SSD module, the first percentage corresponding to the first value of the write credit threshold 208. For instance, when the comparing by the system 100 indicates that the detected operating temperature of the SSD module 118 is less than the throttle temperature, the system 100 may allow the controller 110 to issue as many writes as it has pending to the SSD module 118, as long as the write credit threshold is set at the first value (ex.—is set at a maximum value; is set at a maximum number of write credits).

In further embodiments of the present disclosure, the method 200 may further include the step of, when comparing indicates that the detected operating temperature of the SSD module is greater than the first temperature parameter value, but less than the second temperature parameter value, and when the write credit threshold of the SSD module is established at the first write credit threshold value, adjusting the write credit threshold to a second value, the second write credit threshold value being a lesser value than the first write credit threshold value, and causing the controller to issue a second percentage of its pending writes to the SSD module, the second percentage being less than the first percentage and corresponding to the second value of the write credit threshold 210. For example, when the comparing by the system 100 indicates that the detected operating temperature of the SSD module 118 is greater than the throttle temperature, and the write credit threshold is established at the maximum number of write credits that the SSD module 118 can concurrently support, the system 100 may reduce the write credit threshold, causing the controller 110 to reduce (ex.—throttle) the percentage of its pending writes that it issues to the SSD module 118, thereby reducing power consumption by the SSD module 118 in an effort to reduce the operating temperature of the SSD module 118 to a value below the throttle temperature value. In exemplary embodiments of the present disclosure, the system 100 may detect that the operating temperature of the SSD module 118 is continuing to increase even after the write credit threshold value (and thus, the number of writes issued to that SSD module 118 by the controller 110) have been reduced. In such instances, the system 100 may continue to reduce the write credit threshold value further (ex.—according to a pre-determined rate, according to a pre-determined rate curve, in a pre-determined linear manner, etc.), thereby further reducing the write traffic issued to that SSD module 118, until a choke point is reached.

In exemplary embodiments of the present disclosure, the method 200 may further include the step of, when comparing indicates that the detected operating temperature of the SSD module is equal to or greater than the second temperature parameter value and when the write credit threshold is at a value greater than zero, reducing the write credit threshold to a value equal to zero and causing the controller to stop issuing pending writes to the SSD module 212.

It is to be noted that the foregoing described embodiments according to the present invention may be conveniently implemented using conventional general purpose digital computers programmed according to the teachings of the present specification, as will be apparent to those skilled in the computer art. Appropriate software coding may readily be prepared by skilled programmers based on the teachings of the present disclosure, as will be apparent to those skilled in the software art.

It is to be understood that the present invention may be conveniently implemented in forms of a firmware package and/or a software package. Such a firmware package and/or software package may be a computer program product which employs a computer-readable storage medium including stored computer code which is used to program a computer to perform the disclosed function and process of the present invention. The computer-readable medium/computer-readable storage medium may include, but is not limited to, any type of conventional floppy disk, optical disk, CD-ROM, magnetic disk, hard disk drive, magneto-optical disk, ROM, RAM, EPROM, EEPROM, magnetic or optical card, or any other suitable media for storing electronic instructions.

It is understood that the specific order or hierarchy of steps in the foregoing disclosed methods are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method for optimizing thermal management for a storage controller cache of a data storage system, the method comprising:
establishing a write credit threshold for a solid-state drive (SSD) module of the controller at a first value, the first value being greater than zero;
detecting an operating temperature of the SSD module;
comparing the detected operating temperature of the SSD module with at least one of: a first temperature parameter value of the SSD module and a second temperature parameter value of the SSD module; and
when comparing indicates that the detected operating temperature of the SSD module is less than the first temperature parameter value, and when the write credit threshold of the SSD module is established at the first write credit threshold value, causing the controller to issue a first percentage of the controller's pending writes to the SSD module, the first percentage corresponding to the first value of the write credit threshold.

2. A method for optimizing thermal management as claimed in claim 1, the method further comprising:
when comparing indicates that the detected operating temperature of the SSD module is greater than the first temperature parameter value, but less than the second temperature parameter value, and when the write credit threshold of the SSD module is established at the first write credit threshold value, adjusting the write credit threshold to a second value, the second write credit threshold value being a lesser value than the first write credit threshold value, and causing the controller to issue a second percentage of its pending writes to the SSD module, the second percentage being less than the first percentage and corresponding to the second value of the write credit threshold.

3. A method for optimizing thermal management as claimed in claim 2, the method further comprising:
when comparing indicates that the detected operating temperature of the SSD module is equal to or greater than the second temperature parameter value and when the write credit threshold is at a value greater than zero, reducing the write credit threshold to a value equal to zero and causing the controller to stop issuing pending writes to the SSD module.

4. A method for optimizing thermal management as claimed in claim 1, wherein the first value is equal to a maximum number of outstanding writes the SSD module is able to concurrently support.

5. A method for optimizing thermal management as claimed in claim 1, wherein the write credit threshold is established at a boot time for the system.

6. A method for optimizing thermal management as claimed in claim 1, wherein the write credit threshold is established based upon one of: input/output (I/O) characteristics and thermal characteristics of the SSD module.

7. A method for optimizing thermal management as claimed in claim 1, wherein the first temperature parameter value is a throttle temperature and the second temperature parameter value is a runoff temperature.

8. A method for optimizing thermal management as claimed in claim 7, wherein the runoff temperature is a larger value than the throttle temperature.

9. A method for optimizing thermal management as claimed in claim 1, wherein the first percentage is equal to one-hundred percent.

10. A non-transitory, computer-readable medium having computer-executable instructions for performing a method for optimizing thermal management for a storage controller cache of a data storage system, the method comprising:
establishing a write credit threshold for a solid-state drive (SSD) module of the controller at a first value, the first value being greater than zero;
detecting an operating temperature of the SSD module;
comparing the detected operating temperature of the SSD module with at least one of: a first temperature parameter value of the SSD module and a second temperature parameter value of the SSD module; and
when comparing indicates that the detected operating temperature of the SSD module is less than the first temperature parameter value, and when the write credit threshold of the SSD module is established at the first write credit threshold value, causing the controller to issue a first percentage of the controller's pending writes to the SSD module, the first percentage corresponding to the first value of the write credit threshold.

11. A non-transitory, computer-readable medium having computer-executable instructions for performing a method as claimed in claim 10, the method further comprising:
when comparing indicates that the detected operating temperature of the SSD module is greater than the first temperature parameter value, but less than the second temperature parameter value, and when the write credit threshold of the SSD module is established at the first write credit threshold value, adjusting the write credit threshold to a second value, the second write credit threshold value being a lesser value than the first write credit threshold value, and causing the controller to issue a second percentage of its pending writes to the SSD module, the second percentage being less than the first percentage and corresponding to the second value of the write credit threshold.

12. A non-transitory, computer-readable medium having computer-executable instructions for performing a method as claimed in claim 11, the method further comprising:
when comparing indicates that the detected operating temperature of the SSD module is equal to or greater than the second temperature parameter value and when the write credit threshold is at a value greater than zero, reducing the write credit threshold to a value equal to zero and causing the controller to stop issuing pending writes to the SSD module.

13. A non-transitory, computer-readable medium having computer-executable instructions for performing a method as claimed in claim 10, wherein the first value is equal to a maximum number of outstanding writes the SSD module is able to concurrently support.

14. A non-transitory, computer-readable medium having computer-executable instructions for performing a method as claimed in claim 10, wherein the write credit threshold is established at a boot time for the system.

15. A non-transitory, computer-readable medium having computer-executable instructions for performing a method as claimed in claim 10, wherein the write credit threshold is established based upon one of: input/output (I/O) characteristics and thermal characteristics of the SSD module.

16. A non-transitory, computer-readable medium having computer-executable instructions for performing a method as claimed in claim 10, wherein the first temperature parameter value is a throttle temperature and the second temperature parameter value is a runoff temperature.

17. A non-transitory, computer-readable medium having computer-executable instructions for performing a method as claimed in claim 16, wherein the runoff temperature is a larger value than the throttle temperature.

18. A non-transitory, computer-readable medium having computer-executable instructions for performing a method as claimed in claim 17, wherein the first percentage is equal to one-hundred percent.

19. A data storage system, comprising:
means for establishing a write credit threshold for a solid-state drive (SSD) module of the controller at a first value, the first value being greater than zero;
means for detecting an operating temperature of the SSD module;
means for comparing the detected operating temperature of the SSD module with at least one of: a first temperature parameter value of the SSD module and a second temperature parameter value of the SSD module; and
when comparing indicates that the detected operating temperature of the SSD module is less than the first temperature parameter value, and when the write credit threshold of the SSD module is established at the first write credit threshold value, means for causing the controller to issue a first percentage of the controller's pending writes to the SSD module, the first percentage corresponding to the first value of the write credit threshold.

20. A data storage system as claimed in claim 19, further comprising:
means for, when comparing indicates that the detected operating temperature of the SSD module is greater than the first temperature parameter value, but less than the second temperature parameter value, and when the write credit threshold of the SSD module is established at the first write credit threshold value, adjusting the write credit threshold to a second value, the second write credit threshold value being a lesser value than the first write credit threshold value, and causing the controller to issue a second percentage of its pending writes to the SSD module, the second percentage being less than the first percentage and corresponding to the second value of the write credit threshold; and
means for, when comparing indicates that the detected operating temperature of the SSD module is equal to or greater than the second temperature parameter value and when the write credit threshold is at a value greater than zero, reducing the write credit threshold to a value equal to zero and causing the controller to stop issuing pending writes to the SSD module.
